(19) United States
(12) Patent Application Publication
(10) Pub. No.: US 2026/0200346 A1
(43) Pub. Date: Jul. 16, 2026

(54) CONNECTION DEVICES AND SYSTEMS FOR ELECTRIC DELIVERY

(71) Applicant: Mission Critical Electronics, LLC, Costa Mesa, CA (US)

(72) Inventors: Thomas H. Nugent, JR., Port Jefferson Station, NY (US); Kevin Moschetti, Irvine, CA (US); Vidan Jovanovic, Flushing, NY (US); Anthony M. Imbesi, Nesconset, NY (US); Timothy J. Campbell, Victorville, CA (US); Paul Lamattina, Palm Coast, FL (US)

(21) Appl. No.: 19/074,209

(22) Filed: Mar. 7, 2025

Related U.S. Application Data
(60) Provisional application No. 63/745,208, filed on Jan. 14, 2025.

(51) Int. Cl. B60L 53/16; B60L 53/18; H01R 13/641; H01R 13/66; B60L 53/60

(52) U.S. Cl. CPC B60L 53/16; B60L 53/18; H01R 13/641; H01R 13/6683; B60L 53/60; H01R 2201/26

(57) ABSTRACT

Connection devices and systems for electric delivery. An electrical delivery apparatus includes an electrical delivery apparatus connector, having a mating structure configured to mate with a power inlet of a vehicle, a plurality of electrical contacts configured to deliver power to the vehicle when the connector is fully mated with the power inlet, and an optical detection apparatus configured to detect whether the connector is fully mated with the power inlet. The electrical delivery apparatus includes an electrical line connected to supply power to the electrical delivery apparatus connector. The electrical delivery apparatus includes an enclosure configured to supply power to the electrical line. The electrical delivery apparatus includes a control means configured to control the delivery of power to the electrical line by the enclosure.

### CROSS-REFERENCE TO OTHER APPLICATIONS

This application claims the benefit of the filing date of United States Provisional Patent Application 63/745,208, filed January 14, 2025, which is hereby incorporated by reference. This application includes some subject matter in common with, but is otherwise unrelated to, United States Provisional Patent Application 63/373,288, filed August 23, 2022, United States Provisional Patent Application 63/386,230, filed December 6, 2022, United States Patent Application 17/449,215, filed September 28, 2021, United States Provisional Patent Application 63/113,716, filed November 13, 2020, and United States Patent Application 18/452,323, filed August 18, 2023, all of which are hereby incorporated by reference.

### TECHNICAL FIELD

The present disclosure is directed, in general, to apparatuses, methods, and devices for safely delivering electricity to a vehicle, trailer, or other object. Specific embodiments are directed to electric-power delivery systems with safety features.

### BACKGROUND OF THE DISCLOSURE

Electric vehicles, trailers, and other objects (collectively, “vehicles”) require occasional electric power connections for temporary power or charging purposes. If the power connection is not properly disconnected under certain circumstances, such as when charging is complete or the vehicle is being moved, or is not completely and correctly connected during the power-delivery process, physical or electrical damage can result. Improved systems are desirable.

### SUMMARY OF THE DISCLOSURE

Various disclosed embodiments include an electric delivery apparatus configured to ensure complete and correct electrical and physical connection to an electric vehicle, such as a consumer or commercial automobile. An “electric vehicle” is intended to include hybrid vehicles, trailers, boats, and other vehicles to which a power delivery plug may be attached for charging.

Various embodiments include an electrical delivery apparatus connector, having a mating structure configured to mate with a power inlet of a vehicle, a plurality of electrical contacts configured to deliver power to the vehicle when the connector is fully mated with the power inlet, and an optical detection apparatus configured to detect whether the connector is fully mated with the power inlet.

Various embodiments include an electrical delivery apparatus with an electrical delivery apparatus connector, an electrical line connected to supply power to the electrical delivery apparatus connector, an enclosure configured to supply power to the electrical line, and a control means configured to control the delivery of power to the electrical line by the enclosure.

In various embodiments, the optical detection apparatus includes a mated detect sensor having a photo-emitter and photo-detector pair. In various embodiments, the optical detection apparatus is configured to detect a tab structure of the power inlet when the connector is fully mated with the power inlet. In various embodiments, the optical detection apparatus comprises a flexible printed circuit board that encompasses a slot in the connector and includes an optical sensor configured to detect a tab structure of the power inlet when the connector is fully mated with the power inlet.

In various embodiments, the optical detection apparatus includes a change detect sensor configured to detect a tab structure of the power inlet when the connector being connected to or removed from the power inlet. In various embodiments, the optical detection apparatus includes a first photo-emitter and photo-detector pair configured to detect a tab structure of the power inlet when the connector is fully mated with the power inlet and also includes a second photo-emitter and photo-detector pair configured to detect the tab structure when the connector being connected to or removed from the power inlet.

In various embodiments, the electrical delivery apparatus connector also includes a lid and an impact protection structure.

In various embodiments, electrical delivery apparatus also includes a cable management system configured to keep the electrical line and the connector off of the ground when the connector is not connected to the inlet. In various embodiments, the electrical line has a controlled breakaway device. In various embodiments, the control means is configured to detect welded contacts in a contactor of a power supply. In various embodiments, the control means is configured to only deliver electric power to the electrical line from the enclosure when the optical detection apparatus detects that the connector is fully mated with the power inlet. In various embodiments, the control means is configured to detect an error condition in the electrical delivery apparatus and, in response, to activate an audible indicator and/or a visual indicator.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates an example of a delivery apparatus in accordance with disclosed embodiments;

FIG. 2 illustrates an example of a conventional trailer or vehicle mounted power inlet;

FIGS. 3A and 3B illustrate a connector in accordance with disclosed embodiments;

FIGS. 4, 5, 6, and 7 illustrate various connectors in accordance with disclosed embodiments;

FIG. 8A illustrates an example of the top side of a flex PCB in accordance with disclosed embodiments;

FIG. 8B illustrates an example of the bottom side of flex PCB in accordance with disclosed embodiments;

FIG. 9 illustrates an example of a schematic for a PCB in accordance with disclosed embodiments;

FIG. 10 illustrates an example of a controlled breakaway device in accordance with disclosed embodiments;

FIGS. 11A and 11B illustrate an example of a low-voltage connector connected to and/or part of a breakaway device in accordance with disclosed embodiments;

FIGS. 12A, 12B, and 12C illustrate another example of a low-voltage connector connected to and/or part of a breakaway device in accordance with disclosed embodiments;

FIG. 13 illustrates a non-limiting example of connections that can be made using a 4-conductor plug in accordance with disclosed embodiments.

FIGS. 14A, 14B, and 14C illustrate examples of a connector according to various embodiments;

FIGS. 15 and 16 illustrate examples of cable management systems in accordance with disclosed embodiments; and

FIG. 17 illustrates an example of an interface in accordance with disclosed embodiments;

### DESCRIPTION

The figures referenced below and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Electric vehicles are typically charged by inserting a connector into a power inlet on the vehicle. The connector is connected via a power cord to a power source “enclosure” or “charger” and is configured to insert into the power inlet so that electrical connections are made with the terminals in the power inlet to charge or power the vehicle. Note that the terms “enclosure,” “charger,” and “shore power” may be used interchangeably to describe the power-supply unit providing power to the power cord and connector, since the various embodiments may be applied to shore-power systems that supply A/C operating power to the vehicle and also to charging systems that are also or alternatively used to charge batteries in the vehicle. The enclosure includes a power contactor that supplies power to the power cord.

Currently, to detach a connector from a power inlet, the operator must manually operate a “disconnect” switch on the front panel of the enclosure. This switch causes the power contactor to drop-out and disconnect power from the power cord, connector, and inlet. The operator may then safely pull the connector from the inlet without producing an electrical arc or spark. If the operator forgets to operate this disconnect switch before disconnecting the connector from the inlet, it is very likely that an electrical arc will occur at the connector and inlet contacts. This arc is quite dangerous to the operator/driver, and it also causes considerable damage to the connector and inlet contacts. This damage will cause connector heating and premature connector failure due to increased contact resistance.

Ensuring a proper, safe, and efficient connection between electric vehicle (EV) chargers and vehicles relies on several key protection mechanisms. These are necessary to manage the high currents, prevent electrical faults, and ensure compatibility between different charging systems.

Physical locking mechanisms can include physical connector locks that prevent the charging cable from being disconnected accidentally or prematurely. These locks engage when the connection is active, and they release only when charging is complete or stopped. Many EVs have locking mechanisms on the vehicle side to secure the plug and prevent removal while charging is ongoing, reducing risks associated with arcing or incomplete connections.

Other safety mechanisms can include insulation monitoring devices (IMDs). IMDs continuously monitor the insulation resistance of the high-voltage circuit during charging. If a fault in insulation is detected, the IMD can trigger a shutdown to prevent possible electric shock hazards.

Other safety mechanisms can include ground fault protection. For example, residual current detection (RCD) devices can detect ground faults, where electrical current leaks to the ground rather than returning through the neutral wire. The RCD can trigger an immediate shutdown if they detect leakage currents beyond safe limits to prevent shocks. Ground fault circuit interrupter (GFCI) circuits can automatically disconnect the circuit if an imbalance between live and neutral currents is detected, minimizing shock hazards.

Other safety mechanisms can include communication protocols and compatibility checks. For example, the ISO 15118 standard defines a protocol for communication between the EV and the charger to confirm compatibility and allow functions like Plug and Charge (PnC) and charging session management. The SAE J1772 communication protocol governs AC charging connectors and ensures that EVs and chargers exchange the necessary information to verify compatibility before beginning charging. Chargers and EVs can use charging authentication and verification communications to verify that the connection is safe and compatible (e.g., checking voltage levels and amperage).

Other safety mechanisms can include overcurrent and overvoltage protection, such as circuit breakers that automatically disconnect charging if current levels exceed safe thresholds, protecting the EV and charging station from electrical faults and overloads. These can also include surge protection devices (SPDs) that protect against sudden voltage spikes that could damage the EV's battery or charger components. SPDs can be critical for DC fast chargers and in regions prone to lightning or grid instability.

Other safety mechanisms can include thermal management and overheating protection. Temperature sensors can be embedded within the charger and the connector, monitoring heat buildup during charging. If excessive temperatures are detected, the charging session slows down or stops, preventing thermal damage. High-power chargers, especially DC fast chargers, can use liquid cooling or other cooling system to keep charging connectors and cables within safe operating temperatures, ensuring stable performance and avoiding overheating issues.

Other safety mechanisms can include automated disconnect mechanisms. For example, in an emergency, such as cable damage or a detected fault, an automatic disconnect can cut power immediately to prevent hazardous situations. A charger can also or alternately have an emergency stop button that the operator can press to cut off power instantly if an emergency or malfunction is noticed during charging.

Other safety mechanisms can include arc fault detection and mitigation. Arc fault detection devices (AFDDs) can detect unintended arcing that can occur due to wear or damage to the connector. AFDDs cut the connection if an arc is detected, preventing potential fires or component damage. A pre-charge circuit can be used in DC fast charging to stabilize the voltage before full current flows, reducing the likelihood of arcing during connection.

Other safety mechanisms can include ingress protection (IP) ratings and weatherproofing. Most public EV chargers are rated with high IP levels (e.g., IP54 or higher), which ensures that dust, rain, or other environmental factors don’t compromise the connection quality or safety. Connector and cable reinforcements can provide protection against environmental factors such as UV exposure, temperature extremes, and mechanical wear, ensuring the charging infrastructure remains safe and reliable over time.

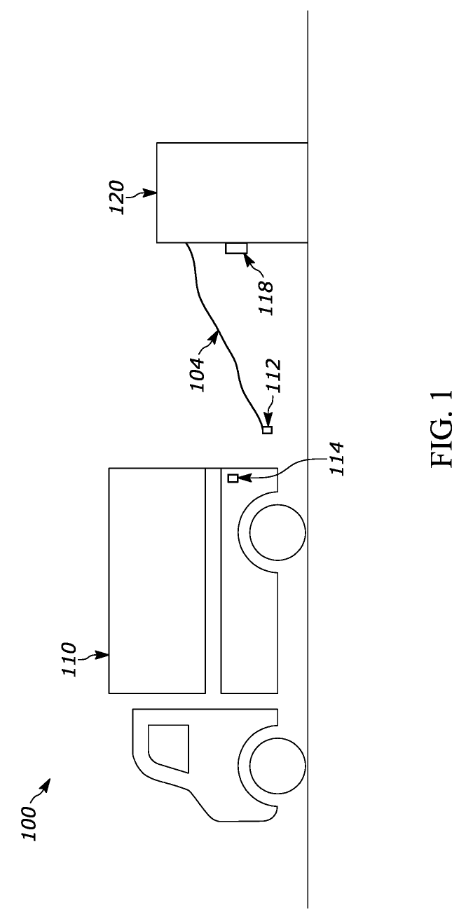

FIG. 1 illustrates an example of an electric delivery apparatus 100 in accordance with disclosed embodiments. Delivery apparatus 100, in this example, includes an electrical line 104, which is one example of a suitable delivery means, that extends from an enclosure 120, which can be, for example, a shore-power source, a battery-charger power source, or other power supply, whether freestanding or attached to some other structure. The electrical line 104 can be connected to a vehicle 110 (or other object) using a connector 112 that is configured to be connected with a receptacle or inlet 114 on the vehicle 110. In the embodiments disclosed herein, “vehicle” refers to and is used to represent any vehicle, trailer, or other machine or object that is connected to an electrical line as described herein.

Various embodiments can also include such elements as booms and extension or retraction mechanisms to control the electrical line 104.

The power to the electrical line 104 may be controlled by a control means 118 on or in enclosure 120. Control means 118 may include one or more user interfaces such as buttons, lights, switches, and the like. Control means 118 may include one or more controllers, memories, or other components to operate as described herein. Control means 118 may also control delivery apparatus 100. Examples of aspects of some possible control means are described herein.

Disclosed embodiments provide safety and personal protection through, among other means, electrical arc prevention at the connector and inlet contacts. This can be accomplished by ensuring a complete and correct connection between the connector and power inlet, and therefor between the electrical contacts of each of these. Grid-sourced AC power will not be supplied to the power cord, connector, and inlet unless the connector is fully mated to the inlet. Additionally, as the connector is manually withdrawn from the inlet, the power supply contactor that switches the grid power to the cord, connector, and inlet will drop out before the contacts between the connector and inlet are broken. This eliminates an electrical arc at the connector and moves it to the contactor, which, unlike the connector and inlet, can be designed for “hot switching.”

Disclosed embodiments use optical sensors to detect when and whether the connector is fully seated into and mated with the electrical inlet. Once mated, in various embodiments, the operator must manually depress a “connect” push-button switch on the front of the enclosure to enable power to the trailer. When mated, the system can alert the operator/driver that the power cord is connected to the vehicle, such as by flashing a beacon light that is mounted on the enclosure.

Various embodiments can include connectors manufactured with optical-sensing devices as described herein and can also include connectors that are adapted or modified to include optical-sensing devices as described herein.

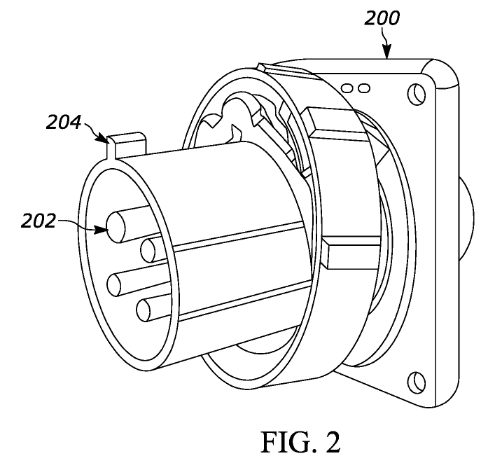

FIG. 2 illustrates an example of a conventional trailer or vehicle mounted power inlet 200. Such an inlet 200 includes a plurality of electrical contacts 202, which must be connected to a connector in a specific orientation in order to assure correct connections and polarities. For this reason, the inlet 200 includes a short polarizing tab 204 at the top, front face of the inlet 200. Note that this tab 204 does not extent the length of the housing of inlet 200. Disclosed embodiments can exploit tab 204 to detect proper connection between a connector as disclosed and a conventional power inlet 200.

Note that the power inlet 200 illustrated in FIG. 2 is structured as conventional inlets where the inlet is female with male contactors and a polarizing tab on a surround structure. The corresponding connector as disclosed herein has a “mating structure” that includes a male body with female contactor receptacles, and a female surround structure that includes a slot for the polarizing tab. When the connecter is mated with the inlet, the male connector body inserts into the inlet surround structure so that the polarizing tab of the inlet slides into the slot in the connector surround structure.

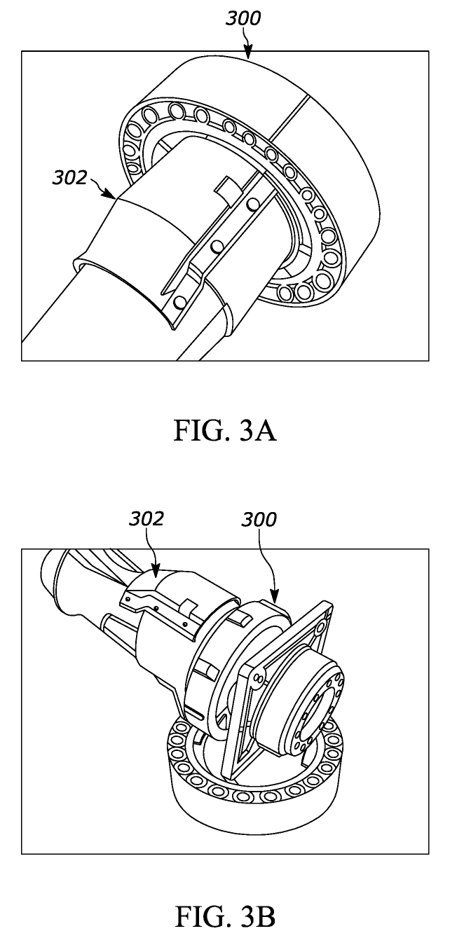

FIGS. 3A and 3B illustrate an electric delivery apparatus connector 300 in accordance with disclosed embodiments, from two different views. Connector 300 has a mating structure configured to connect to and mate with with power inlet 200 on a vehicle. Connector 300 includes, in addition to some conventional features, an optical detection apparatus 302, described in more detail below, that replaces the simple slot of the connector surround structure and interacts with tab 204 of the conventional power inlet 200. As described in more detail herein, the optical detection apparatus is configured to detect when the connector is fully mated with the power inlet.

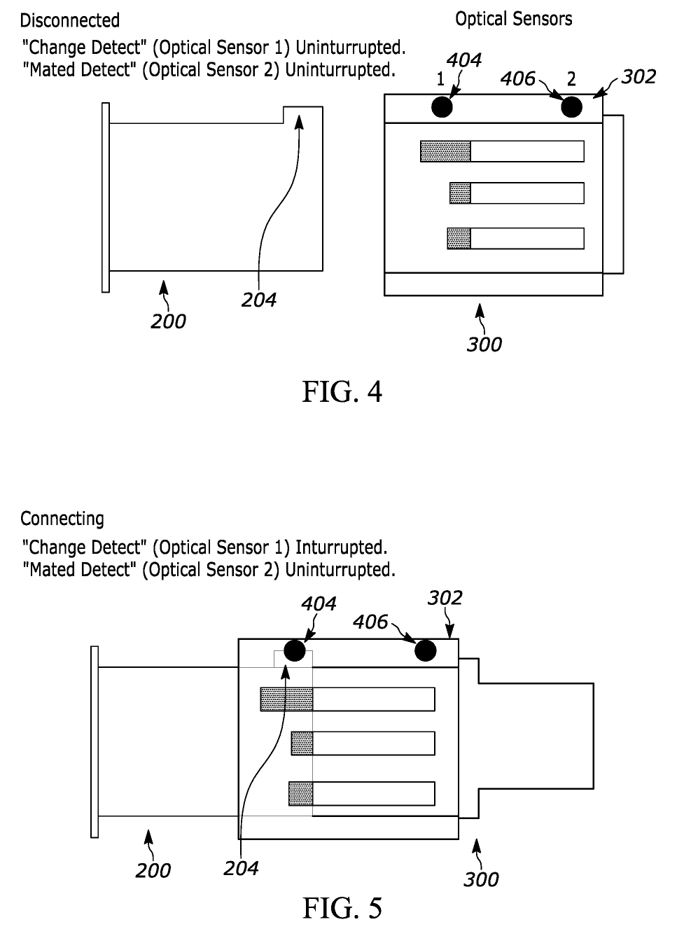

FIG. 4 illustrates a connector 300 in accordance with disclosed embodiments, disconnected from a power inlet 200 on a vehicle. Power inlet 200 includes polarization tab 204. Connector 300 includes an optical detection apparatus 302, which attached to (or integrated with) the body of the connector 300, that has a pair of photo-interrupters 404/406.

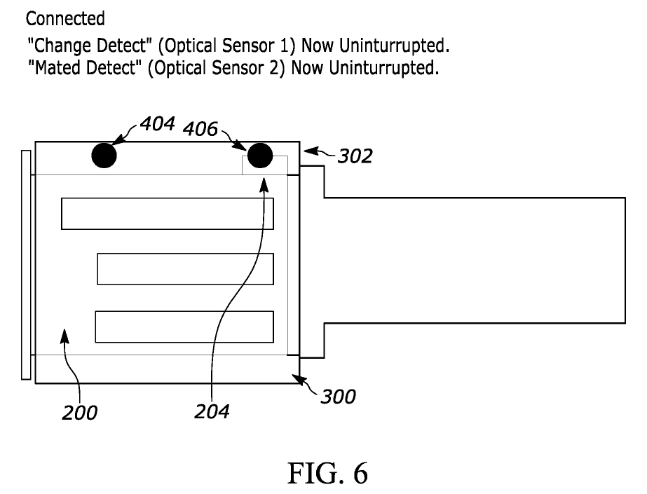

FIG. 5 illustrates a connector 300 in accordance with disclosed embodiments, in the process of connecting to (being mated with) a power inlet 200 on a vehicle. At this point, the first photo-interrupter 404 of optical detection apparatus 302 is momentarily triggered by polarization tab 204 as the connector 300 is being connected to the inlet 200. Control means 118 can detect this momentary trigger of photo-interrupter 404 to determine that the connector 300 is being connected to (but is not yet fully connected to) power inlet 200. Note that the reverse is also true, in that control means 118 can detect the momentary trigger of photo-interrupter 404, after it has detected full connection, to determine that the connector 300 is being removed from power inlet 200.

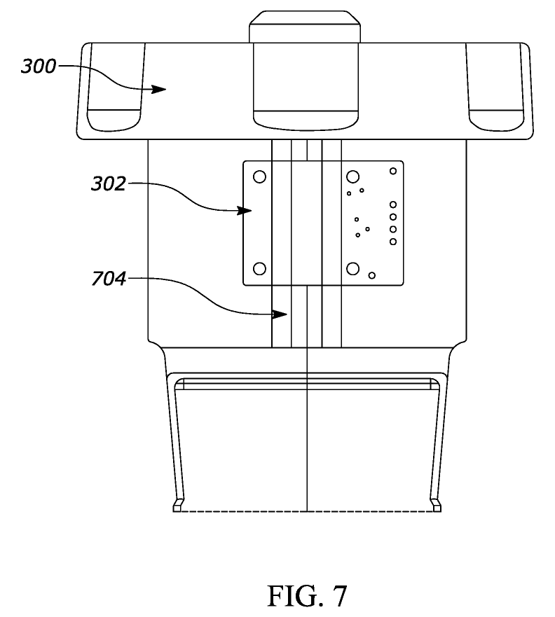

FIG. 6 illustrates a connector 300 in accordance with disclosed embodiments, connected to (fully mated with) a power inlet 200 on a vehicle. At this point, the first photo-interrupter 406 of optical detection apparatus 302 is activated by polarization tab 204 since the connector 300 is fully connected to the inlet 200. The depth of the surround structure of connector 300 and the placement of photo-interrupter 406 are configured that, when fully connected, polarization tab 204 fully activates photo-interrupter 406, which remains activated as long as connector 300 is fully mated with the inlet 200. Control means 118 can detect this trigger of photo-interrupter 406 to determine that the connector 300 is fully connected to power inlet 200.

In various embodiments, control means 118 will only supply power to the connector when it has determined that the connector 300 is fully connected to power inlet 200.

In various embodiments, the delivery apparatus 100 can signal that the connector 300 is fully connected to power inlet 200. For example, the control means 118 can illuminate an LED indicator on the connector handle or the enclosure while the connector is fully mated with the inlet.

In various embodiments, control means 118 can also sense an error condition when both photo-interrupter 404 and photo-interrupter 406 are simultaneously blocked (activated). This may indicate, for example, that a foreign object has been inserted into optical detection apparatus 302. No power will be supplied while in this state.

To manually disable power, in various embodiments, the operator/driver must depress a “disconnect” push-button switch on the front of the enclosure 120, such as on control means 118. In response, the control means 118 opens the contactor, disabling power to the cord, connector, and inlet. The beacon lamp or other alert mechanism can continue to activate until the connector is fully unmated from the trailer inlet.

Control means 118 can be configured to detect any other errors, faults, or conditions described herein and to perform safety functions to control, remove, or limit power delivery as needed.

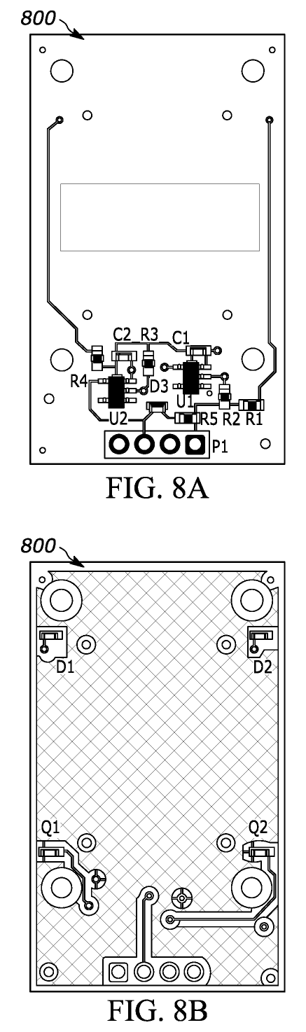

FIG. 7 illustrates a top view of connector 300 in accordance with disclosed embodiments. This figure illustrates optical detection apparatus 302 that encompasses slot 704 in the connector 300. Slot 704 and optical detection apparatus 302 receive polarization tab 204 as described herein. Note that slot 704 may not be open at the top.

In the non-limiting example of FIG. 7, optical detection apparatus 302 is implanted using a flexible printed circuit board (PCB) that wraps over the slot 704. The LEDs and phototransistors that comprise photo-interrupter 404 and photo-interrupter 406 are not visible because they are mounted on the underside of the flex PCB. Each LED of photo-interrupter 404 and photo-interrupter 406 projects a beam of light across the slot 704 to a corresponding phototransitor on the opposite side of the photo-interrupter 404 and photo-interrupter 406. The forward pair of a photo-emitter (LED) and a photo-detector (phototransistor), together comprising photo-interrupter 404, form a “change detect” sensor. The forward pair of a photo-emitter (LED) and a photo-detector (phototransistor), together comprising photo-interrupter 406, form a “mated detect” sensor.

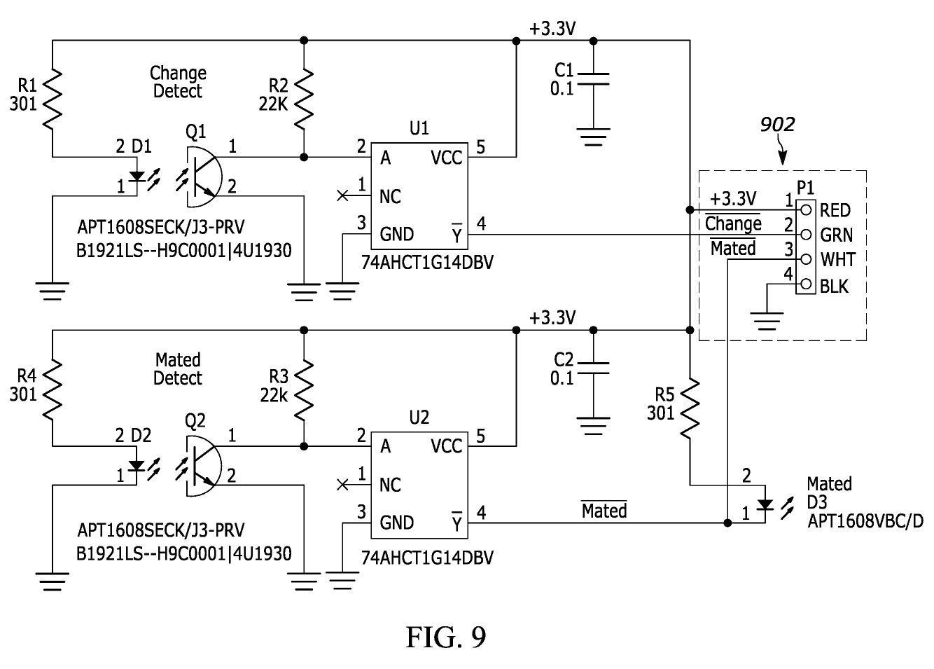

FIG. 8A illustrates a non-limiting example of the top side of a PCB 800 that can be used to implement optical detection apparatus 308, and FIG. 8B illustrates a non-limiting example of the bottom side of flex PCB 800 that can be used to implement optical detection apparatus 308. PCB 800 in FIG. 8A shows a mated operator indicator LED (D3), Schmitt Trigger Inverters (U1 and U2), and other components. PCB 800 in FIG. 8A shows LEDs (D1 and D2) and phototransistors (Q1 and Q2) that form the photo-interrupters 404 and 406, where D1 and Q1 perform “Change Detect” and D2 and Q2 perform the “Mated Detect” functions. PCB 800 can be manufactured using conventional components, and the flexible PCB 800 can be shaped to cover (or form) slot 704 to detect the polarization tab 204.

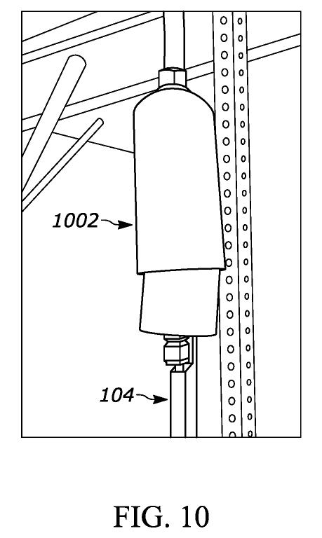

FIG. 9 illustrates a non-limiting example of a schematic 900 for a PCB that can be used to implement optical detection apparatus 308. Circuit portion 902 illustrates one example of connector signals for optical detection apparatus 308. In this example of circuit portion 902, connector 1 is a 3.3V power source used to power the optical detection apparatus 308, and connector 4 is the corresponding ground connection. “Change” connector 2 is the “Change Detect” signal that detects when the connector is in the process of being inserted or removed, and “Mated” connector 3 is the “Mated Detect” signal that is used to determine whether the connector is fully mated with the receptacle. Note that specific details of the connector signals herein, such as color designations, specific voltages, and pin assignments are exemplary and may vary in different implementations.

In various embodiments, control means 118 can also to detect welded contacts, to prevent operation in the case of the contacts of a contactor of a power supply becoming welded in the closed position. For example, when a welded contact is detected, control means 118 can activate an alert such as a rapidly-flashing beacon light, an audible alarm, and/or other alert mechanism to alert the operator of this error condition. In such cases, for example, the charger or connector can be removed from service until the faulty contactor has been replaced.

Various embodiments also include a controlled breakaway device to minimize damage and possible harm during accidental drive-off events. Accidental drive-off events occur when a vehicle is moved away from the charger without manually disconnecting the connector from the inlet. These events cause a very hazardous condition and do considerable damage as the power cord is often ripped from the charger. Disclosed embodiments use a controlled breakaway device to maximize safety and minimize damage to the system in the event of an accidental drive-off.

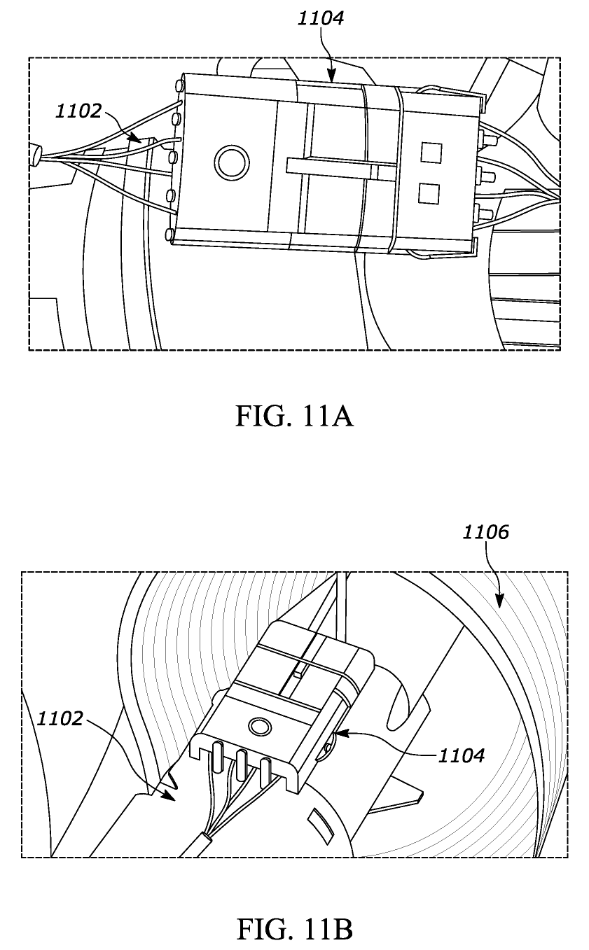

FIG. 10 illustrates an example of a controlled breakaway device 1002 in an electrical line 104 in accordance with disclosed embodiments. Breakaway device 1002 can include mated electrical connectors that are covered by a weatherproof separable cover.

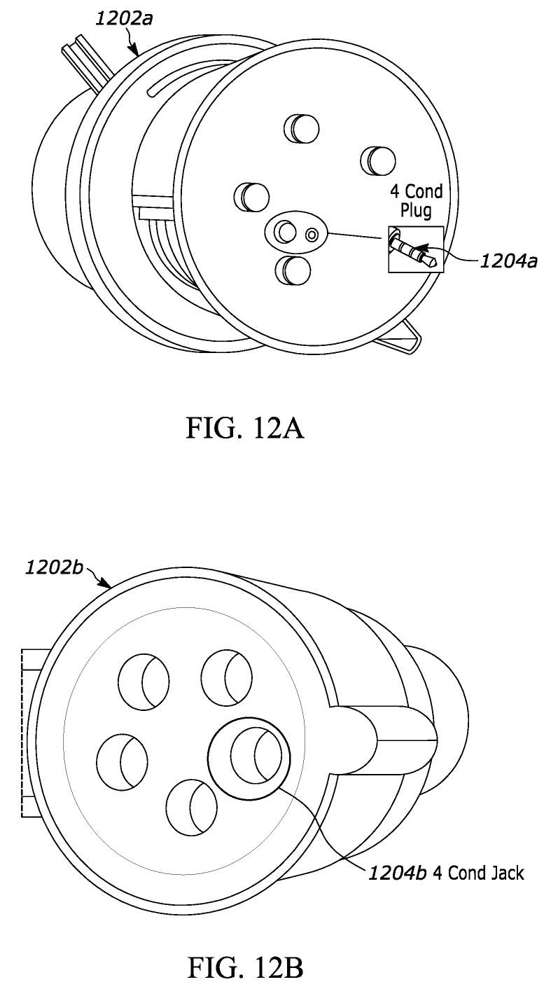

FIGS. 11A and 11B illustrate an example of a low-voltage connector 1104 connected to and/or part of a breakaway device 1102 in accordance with disclosed embodiments. Breakaway device 1102 can used, for example, to implement a breakaway device 1002, where the low-voltage connector 1104 is located within a weatherproof separable cover 1106. In this example, the low-voltage connector 1104 itself can breakaway with the breakaway device 1102, disconnecting one or more low-voltage connections as shown in the illustration.

In various embodiments, low-voltage connector 1104 can be implemented using weatherproof automotive connectors with any standard latching/locking mechanism removed to allow the two halves of the low-voltage connector 1104 to separate more easily.

In various embodiments, low-voltage connector 1104 is used to make the connections as illustrated in circuit portion 902 of FIG. 9.

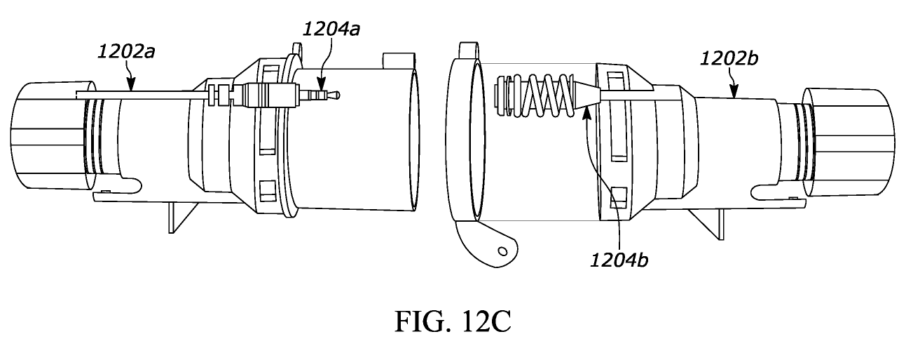

FIGS. 12A, 12B, and 12C illustrate another example of a low-voltage connector 1204 connected to and/or part of a breakaway device 1202 (shown separated into connector 1202a in FIG. 12A and connector 1202b in FIG. 12B) in accordance with disclosed embodiments. Breakaway device 1202 can used, for example, to implement a breakaway device 1002.

In this example, breakaway device 1202 is implemented using a modified 5-pin, pin-and-sleeve style electrical plug and receptacle with one of the power contacts in each replaced with a 4-conductor plug 1204a and corresponding 4-conductor jack 1204b. These connectors are normally used in audio applications and are often referred to as TRRS (Tip, Ring, Ring, Sleeve) connectors. In this example, the low-voltage connector 1204a/b itself can breakaway with the breakaway device 1202, disconnecting one or more low-voltage connections.

FIG. 12C illustrates another view of breakaway device 1202 (shown separated into connector 1202a and connector 1202b) and an integrated low-voltage connector implemented using 4-conductor plug 1204a and corresponding 4-conductor jack 1204b.

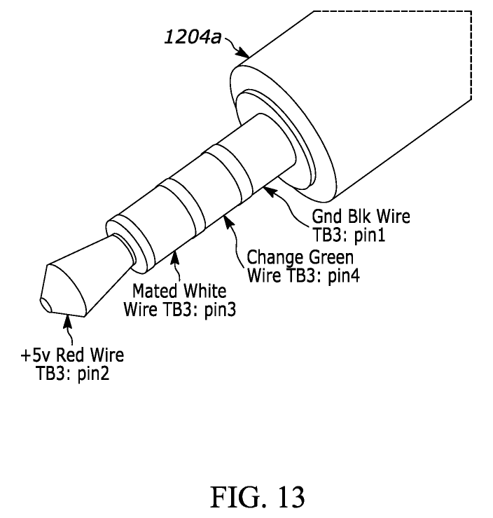

FIG. 13 illustrates a non-limiting example of connections that can be made using 4-conductor plug 1204a, in accordance with disclosed embodiments. These connections can, for example, generally correspond to the connections shown circuit portion 902 of FIG. 9 for optical detection apparatus 308; note that color designations are also simply an example and are non-limiting. In this example, the “tip” connection indicated as pin2 is a 5V power source used to power the optical detection apparatus 308, and the “sleeve” connection indicated as pin1 is the corresponding ground connection. The ”Mated” connector at the distal ring indicated as pin3 is the “Mated Detect” signal that is used to determine whether the connector is fully mated with the receptacle, and the “change” at the proximal ring indicated as pin4 is the “Change Detect” signal that detects when the connector is in the process of being inserted or removed. Again, specific details of the connections as described herein, such as color designations, specific voltages, and pin assignments, are exemplary and may vary in different implementations.

According to various embodiments, a connector can include a lid to prevent water intrusion while not in use. The lid has impact protection around its circumference to reduce the possibility of connector damage when the connector is dropped and hits the ground or an adjacent wall.

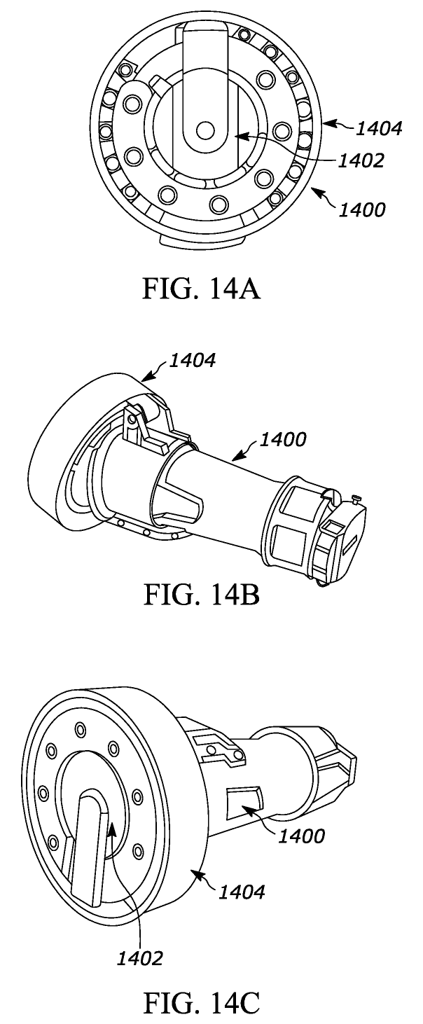

FIGS. 14A, 14B, and 14C illustrate examples of a connector 1400 having a lid 1402 and impact protection 1404, according to various embodiments.

Various embodiments do not require modification of conventional power inlets on the vehicle, so that the various advantages described herein can be obtained for any such vehicle.

Disclosed embodiments include a charging system and/or power supply system as part of enclosure 120, with components such as cables, switches, relays, contactors, indicators, and printed circuit board assemblies with embedded microcontrollers. These components can be located, for example, in a waterproof enclosure on the connector/power supply “charger” side.

Various embodiments can also include cable management systems to manage the electrical line 104 and connector 112 of delivery apparatus 100.

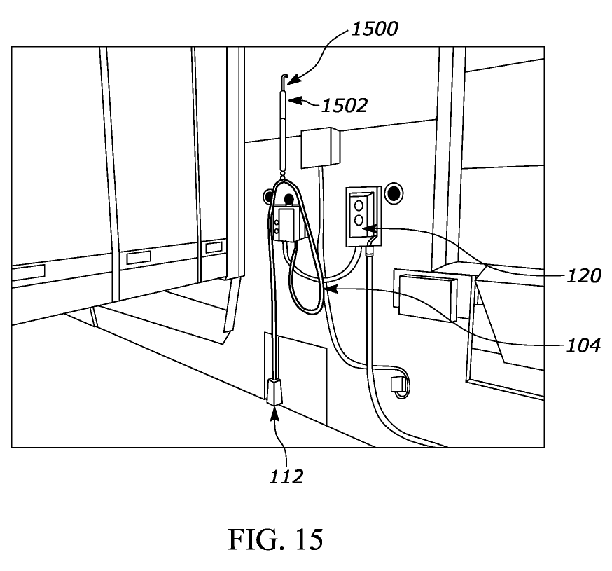

FIG. 15 illustrates an example of a cable management system 1500 in accordance with disclosed embodiments. This figure shows an enclosure 120 (which may include a control means 118) attached to the side of a building. Enclosure 120 is connected to electrical line 104 which has a connector 112, such as connector 300.

In this example, the cable management system 1500 can include a wall-mounted spring tender 1502 with cable strain relief to keep the electrical line 104 suspended from the ground. This method of cable management keeps the connector 112 off the ground and eliminates a tripping hazard for workers. Additionally, this method protects the connector 112 from standing water and reduces the risk of electric shock.

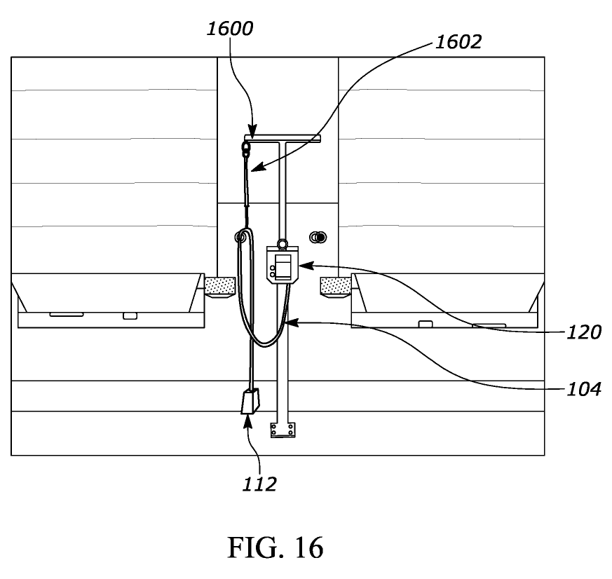

A cable management system as disclosed can easily adapt between a wall-mounted or a pedestal mounted gantry. A pedestal-mounted gantry allows for stand-alone parking lot applications. FIG. 16 illustrates an example of a cable management system 1600 in accordance with disclosed embodiments. This figure shows an enclosure 120 (which may include a control means 118) attached to the pedestal. Enclosure 120 is connected to electrical line 104 which has a connector 112, such as connector 300.

In this example, the cable management system 1600 can include a mounted spring tender 1602, mounted on a gantry on the pedestal, with cable strain relief to keep the electrical line 104 suspended from the ground.

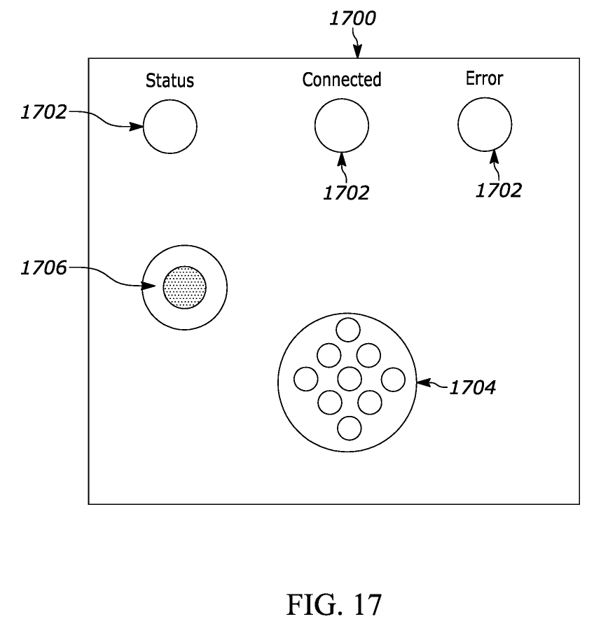

FIG. 17 illustrates an example of an interface of a control means 118 on an enclosure 120. In this example, the interface 1700 can include a plurality of indicators 1702, such as light-emitting diode (LED) lights, lamps, or other visual indicators. In this example, the indicators 1702 can include a status indicator, a connected indicator, and an error indicator, and the indicators 1702 can light up, change colors, or flash as may be appropriate. Interface 1700 can also include a speaker or other audio interface 1704 for giving audible feedback, whether an audible indicator such as alarm sounds, alerts, voice responses, or otherwise. Audio interface 1704 can also include a microphone system for audible inputs, for example, when control means 118 can be voice controlled. Interface 1700 can include one or more input devices 1706, which can include pushbuttons, touchscreens, or other input devices, that can be used to perform functions as described herein, such as connect/disconnect buttons.

Of course, those of skill in the art will recognize that, any of the features described above for different embodiments, or in the incorporated applications, can be combined with others for still further embodiments within the scope of the disclosure.

Those skilled in the art will recognize that, for simplicity and clarity, the full structure and operation of all systems or mechanisms suitable for use with the present disclosure is not being depicted or described herein. Instead, only so much of a delivery apparatus as is unique to the present disclosure or necessary for an understanding of the present disclosure is depicted and described. The remainder of the construction and operation of the embodiments above may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form. Specific structures, dimensions, shapes, voltages, connections, commercial products, and other features described or illustrated herein are non-limiting unless specifically claimed.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words "means for" are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. §112(f).

What is claimed is:

1. An electrical delivery apparatus connector, comprising:
a mating structure configured to mate with a power inlet of a vehicle;
a plurality of electrical contacts configured to deliver power to the vehicle when the connector is fully mated with the power inlet; and
an optical detection apparatus configured to detect whether the connector is fully mated with the power inlet.

2. The electrical delivery apparatus connector of claim 1, wherein the optical detection apparatus includes a mated detect sensor having a photo-emitter and photo-detector pair.

3. The electrical delivery apparatus connector of claim 1, wherein the optical detection apparatus is configured to detect a tab structure of the power inlet when the connector is fully mated with the power inlet.

4. The electrical delivery apparatus connector of claim 1, wherein the optical detection apparatus comprises a flexible printed circuit board that encompasses a slot in the connector and includes an optical sensor configured to detect a tab structure of the power inlet when the connector is fully mated with the power inlet.

5. The electrical delivery apparatus connector of claim 1, wherein the optical detection apparatus includes a change detect sensor configured to detect a tab structure of the power inlet when the connector being connected to or removed from the power inlet.

6. The electrical delivery apparatus connector of claim 1, wherein the optical detection apparatus includes a first photo-emitter and photo-detector pair configured to detect a tab structure of the power inlet when the connector is fully mated with the power inlet and a second photo-emitter and photo-detector pair configured to detect the tab structure when the connector being connected to or removed from the power inlet.

7. The electrical delivery apparatus connector of claim 1, further comprising a lid and an impact protection structure.

8. An electrical delivery apparatus comprising:
an electrical delivery apparatus connector, having
a mating structure configured to mate with a power inlet of a vehicle,
a plurality of electrical contacts configured to deliver power to the vehicle when the connector is fully mated with the power inlet, and
an optical detection apparatus configured to detect whether the connector is fully mated with the power inlet;
an electrical line connected to supply power to the electrical delivery apparatus connector;
an enclosure configured to supply power to the electrical line; and
a control means configured to control the delivery of power to the electrical line by the enclosure.

9. The electrical delivery apparatus of claim 8, wherein the optical detection apparatus includes a mated detect sensor having a photo-emitter and photo-detector pair.

10. The electrical delivery apparatus of claim 8, wherein the optical detection apparatus is configured to detect a tab structure of the power inlet when the connector is fully mated with the power inlet.

11. The electrical delivery apparatus of claim 8, wherein the optical detection apparatus comprises a flexible printed circuit board that encompasses a slot in the connector and includes an optical sensor configured to detect a tab structure of the power inlet when the connector is fully mated with the power inlet.

12. The electrical delivery apparatus of claim 8, wherein the optical detection apparatus includes a change detect sensor configured to detect a tab structure of the power inlet when the connector being connected to or removed from the power inlet.

13. The electrical delivery apparatus of claim 8, wherein the optical detection apparatus includes a first photo-emitter and photo-detector pair configured to detect a tab structure of the power inlet when the connector is fully mated with the power inlet and a second photo-emitter and photo-detector pair configured to detect the tab structure when the connector being connected to or removed from the power inlet.

14. The electrical delivery apparatus of claim 8, further comprising a cable management system configured to keep the electrical line and the connector off of the ground when the connector is not connected to the inlet.

15. The electrical delivery apparatus of claim 8, wherein the electrical line has a controlled breakaway device.

16. The electrical delivery apparatus of claim 8, wherein the control means is configured to detect welded contacts in a contactor of a power supply.

17. The electrical delivery apparatus of claim 8, wherein the control means is configured to only deliver electric power to the electrical line from the enclosure when the optical detection apparatus detects that the connector is fully mated with the power inlet.

18. The electrical delivery apparatus of claim 8, wherein the control means is configured to detect an error condition in the electrical delivery apparatus and, in response, to activate an audible indicator and/or a visual indicator.
